(19) United States
(12) Patent Application Publication
(10) Pub. No.: US 2014/0115945 A1
(43) Pub. Date: May 1, 2014

(54) FISH SPEAR

(71) Applicants: Atsushi KIDACHI, (US); Misako KIDACHI, (US); Tomoya KIDACHI, (US); Eri KIDACHI, (US); TAKASHIMA SHOTEN CO., LTD, Tokyo-to (JP)

(72) Inventor: Motohiro NIKI, Tokyo-to (JP)

(73) Assignees: Atsushi KIDACHI, Chiba-ken (JP); Misako KIDACHI, Chiba-ken (JP); TAKASHIMA SHOTEN CO., LTD., Tokyo-to (JP); Eri KIDACHI, Chiba-ken (JP); Tomoya KIDACHI, Chiba-ken (JP)

(21) Appl. No.: 13/728,203

(22) Filed: Dec. 27, 2012

(30) Foreign Application Priority Data
Oct. 30, 2012 (JP) 2012-239338

(51) Int. Cl. A01K 81/04; A01K 81/06

(52) U.S. Cl. CPC A01K 81/04; A01K 81/06
USPC 43/6

(57) ABSTRACT

A fish spear (1) has a function to lure a fish (17) effectively underwater. The fish spear has a spearhead (2) and a shaft (3) connected to the spearhead. The spearhead has a spearing tip (5) to be thrust into a target fish, and a bait holder (6) for holding a baitfish (16) for luring a target fish.

### BACKGROUND OF THE INVENTION

1. Technical Field

The present invention relates to a fish spear for spearing a fish underwater and, more specifically to a fish spear for spearing a fish by luring the fish with bait undersea.

2. Background Art

Diving into the sea and spearing fishes individually with a fish spear in the sea gives a thrilling pleasure and is an attractive recreational sport.

A fisher tries to find a fish swimming before him, approaches the fish such that the fish is within the range of the fish spear, and then spears the fish with the fish spear to catch the fish.

### SUMMARY OF THE INVENTION

### Problem to be Solved by the Invention

The conventional fish spear for spearing a fish does not have any function to attract a fish to the fisher using the fish spear.

Therefore, when a fish lurks, for example, behind a rock and cannot be sighted, the fisher is obliged inevitably to wait until the fish comes out from behind the rock.

Even if the fisher finds a fish swimming across a space extending before the fisher, the fish will swim away and cannot be effectively attracted if the fisher fails in throwing the fish spear toward the fish in proper timing.

Accordingly, it is an object of the present invention to solve those problems in the prior art and to provide a fish spear having a function to lure a fish effectively.

### Means for Solving the Problem

The present invention provides a fish spear, to be used underwater for spearing a fish, including a spearhead; and a shaft connected to the spearhead; wherein the spearhead has a spearing tip to be thrust into a fish to catch the fish, and a bait holder attached to the spearing tip to hold bait for luring a fish.

The spearing tip has a sharp point and expands toward its rear end thereof, and the bait holder is attached to the spearing tip.

The bait holder is extended along the outside surface of the spearing tip such that the bait holder can be thrust into a fish together with the spearing tip.

The bait holder is provided with a barb for preventing bait put on the bait holder from falling off the bait holder.

A transverse connector provided with an internal screw thread is attached to opposite inside parts of the spearing tip, the shaft has an externally threaded end, and the externally threaded end of the shaft is screwed into the internal screw thread of the transverse connector.

The externally threaded end of the shaft can be screwed into each of spearing tips of different types.

A string for controlling the thrown spearhead and shaft is connected to the externally threaded end of the shaft and is extended through the shaft.

The fish spear further includes a gunbarrel for holding and discharging the spearhead and the shaft, a driving means for discharging the spearhead and the shaft from the gunbarrel, and a trigger mechanism for actuating the driving means.

### BRIEF DESCRIPTION OF THE DRAWINGS

FIG. 1 is a longitudinal sectional view of a fish spear in a first embodiment according to the present invention;

FIG. 2 is a plan view of a string extended through the shaft of the fish spear;

FIG. 3 is a sectional view of the joint of a spearhead and a shaft;

FIG. 4 is a longitudinal sectional view of the spearhead holding a baitfish on a bait holder;

FIG. 5 is a longitudinal sectional view of a spear gun provided with a fish spear of the present invention;

FIG. 6 is a pictorial view of a fisher fishing with a fish spear of the present invention underwater; and

FIG. 7 is a plan view of a fish spear in a second embodiment according to the present invention.

### BEST MODE FOR CARRYING OUT THE INVENTION

A fish spear 1 in a first embodiment according to the present invention will be described with reference to the drawings.

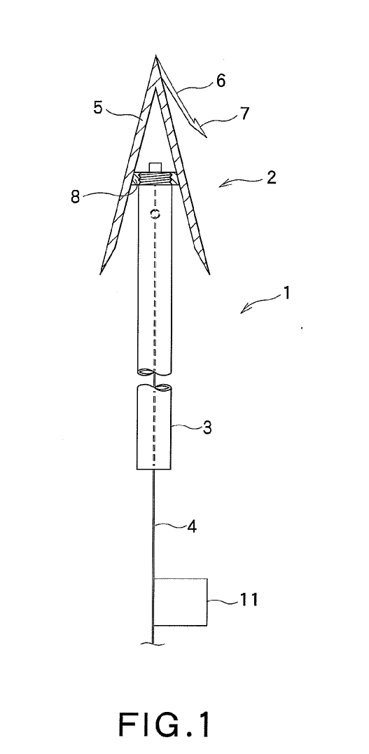

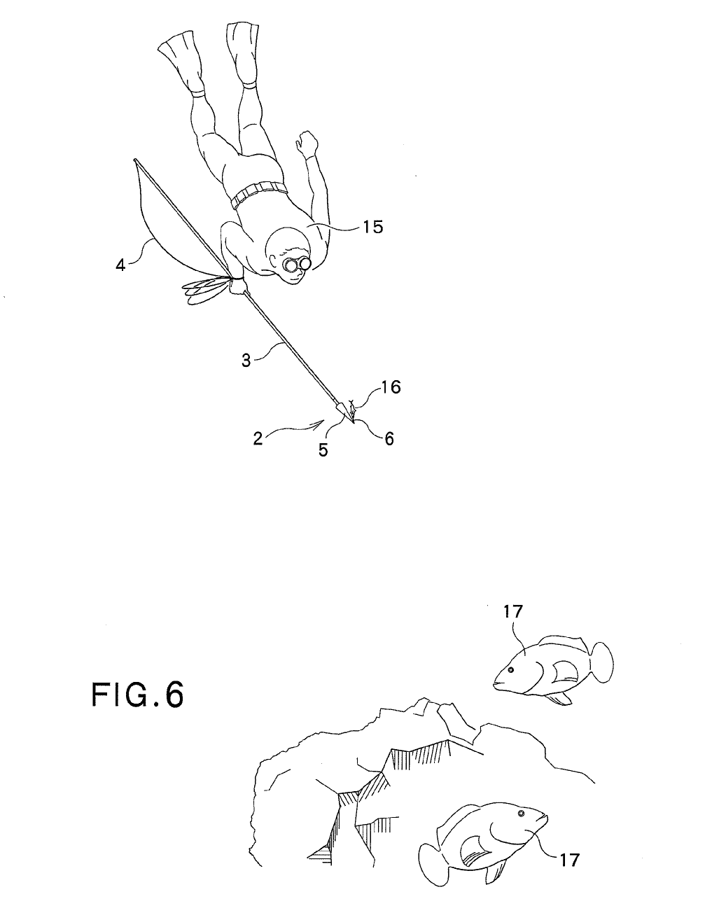

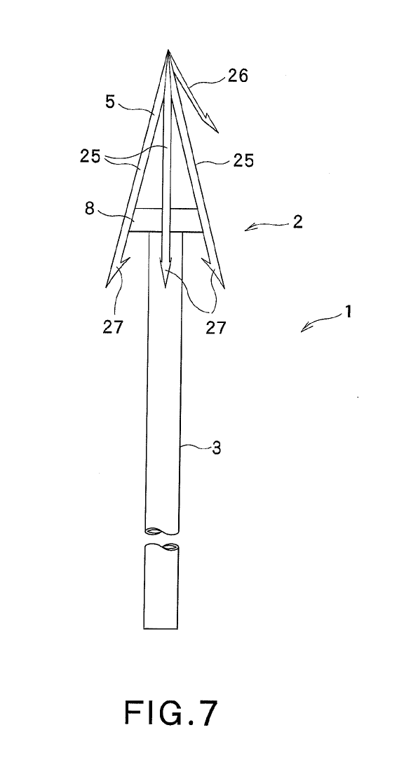

Referring to FIG. 1, the fish spear 1 includes a spearhead 2, a shaft 3 and a string 4. The spearhead 2 includes a spearing tip 5 which is thrust into a fish 17 (FIG. 7), and a bait holder 6 attached to the spearing tip 5 to hold a baitfish 16 (FIG. 6).

The spearing tip 5 has the shape of a circular cone expanding toward the rear thereof. The spearing tip 5 is made of a metal or a ceramic material.

The bait holder 6 is attached to the sharp tip of the spearing tip 5 by welding or the like. The bait holder 6 has the shape of a sharp needle or a fish hook. The bait holder 6 is provided on its end part with a barb 7 for preventing a baitfish 16 from falling off the bait holder 6. The bait holder 6 can be thrust into a fish together with the spearing tip 5. The bait holder 6 is extended along the outside surface of the spearing tip 5 having the shape of a circular cone.

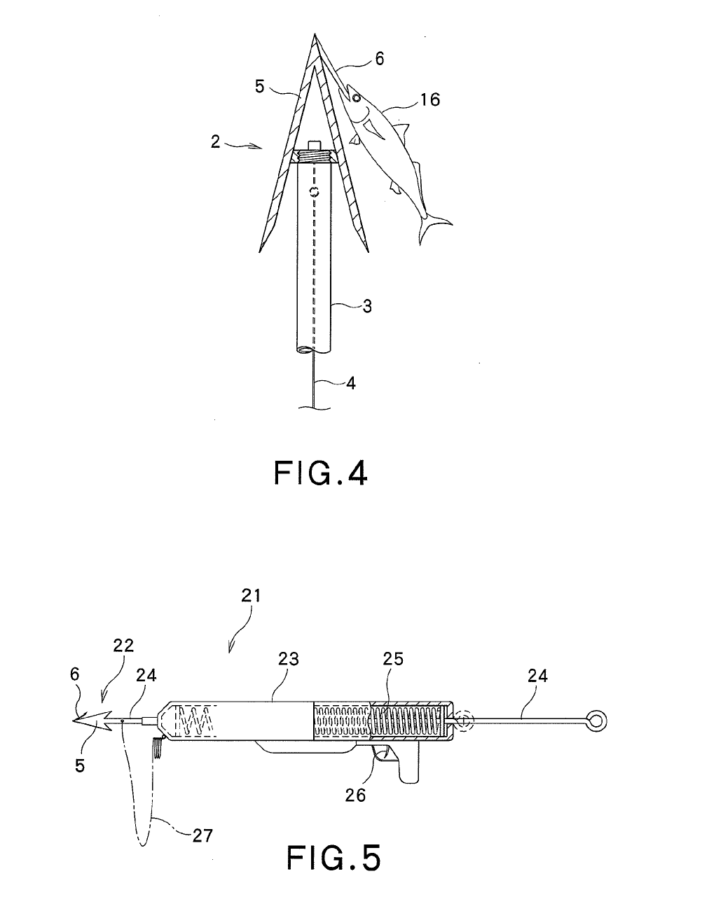

As shown in FIG. 4, the baitfish 16 is held on the bait holder 6 by the barb 7. The species and the size of the baitfish 16 may be selectively determined according to the species of a target fish 17.

As shown in FIG. 3, the spearing tip 5 is internally provided with a transverse connector 8. The transverse connector 8 is attached to opposite inside parts of the spearing tip 5 by welding or the like. The transverse connector 8 has an axial through hole provided with an internal screw thread 8a. The shaft 3 has an end part provided with an external screw thread 3a capable of being engaged with the internal screw thread 8a. The shaft 3 can be connected to the spearhead 2 by engaging the external screw thread 3a with the internal screw thread 8a. Thus, the spearhead 2 can be easily connected to the shaft 3 by simply screwing the spearhead 2 on the shaft 3. The transverse connector 8 has a function to reinforce the spearing tip 5 also.

The shape of the spearhead 2 is dependent on the specific characters including size and behavior of the target fish 17. Therefore, it is preferable to keep plural spearheads 2 of different shapes and to select suitable one of the spearheads 2 to achieve pleasant fishing efficiently.

To use suitable one of the spearheads 2 selectively in combination with the single shaft 3, the spearheads 2 are provided, respectively, with transverse connectors 8 having axial through holes provided with the same internal screw thread 8a.

FIG. 7 shows a spearhead 2 of a fish spear 1 in a second embodiment according to the present invention.

The spearhead 2 shown in FIG. 7 has a spearing tip 5 different from the spearing tip 5 having the shape of a circular cone shown in FIG. 1. The spearing tip 5 of the spearhead 2 shown in FIG. 7 has three spearing bars 25 each provided on its free end with a barb 27. The spearing tip 5 shown in FIG. 7, similarly to the spearing tip 5 shown in FIG. 1, is provided with a transverse connector 8 for connecting the spearing tip 5 to the shaft 3. Although the manufacturing cost of the spearhead 2 shown in FIG. 7 is high as compared with that of the spearhead 2 shown in FIG. 1 because the shape of the spearhead 2 shown in FIG. 7 is more complicated than that of the spearhead 2 shown in FIG. 1, the spearhead 2 shown in FIG. 7 is relatively lightweight. Therefore, the spearhead 2 shown in FIG. 7 can be formed in a relatively large size. Since the spearhead 2 shown in FIG. 7 is provided with the barbs 27, a target fish 17 speared by the spearhead 2 shown in FIG. 7 is difficult to fall off the spearhead 2. Since the spear tip 5 has three spearing bars 25, the spearhead 2 can be thrust into the target fish 17 against a comparatively low resistance and hence the spearhead 2 shown in FIG. 7 is suitable for catching a large fish. Since the spearing tip 5 having the shape of a circular corn shown in FIG. 1 can be thrust smoothly into a fish 17, damage to the fish 17 can be lightened.

Preferably, the plural spearheads 2 are provided, respectively, with bait holders 6 respectively having different shapes including shapes of different fishhooks or the like.

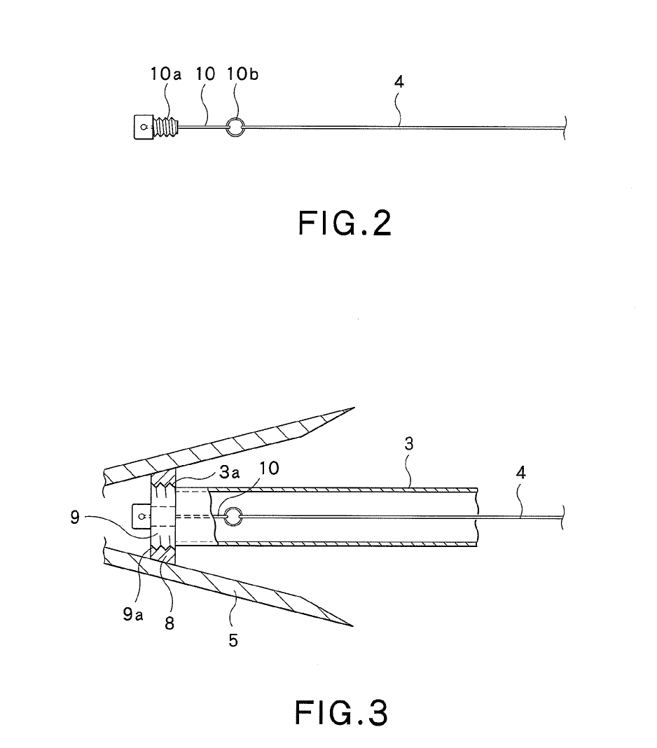

A front end 9 of the shaft 3 has the shape of a solid bar, and the rest part of the same has a tubular shape. The front end 9 has an axial through hole provided with an internal screw thread. As shown in FIG. 2, the front end of the string 4 is connected to a ring 10b at the rear end of a bar-shaped solid connector 10. The connector 10 is provided with an external screw thread 10a mating with the internal screw thread of the front end 9 of the shaft 3.

The length of the shaft 3 is, for example, in the range of 3 to 4 m. The length of the string 4 is far longer than that of the shaft 3. A flag 11 is attached to the string 4 as a mark for the convenience of the fisher 15. After the spearhead 2 and the shaft 3 have been thrown toward the fish 17, the fisher 15 pulls the string 4 to draw the speared fish 17, the spearhead 2 and the shaft 3 toward the fisher 15.

A method of assembling the spearhead 2, the shaft 3 and the string 4 will be described. First, the string 4 is connected to the ring 10b of the connector 10, the string 4 and the connector 10 are passed through the shaft 3, the external screw thread 19a of the connector 10 is engaged with the internal screw thread formed in the front end 9 of the shaft 3 to assemble the shaft 3, the connector 10 and the string 4.

Secondly, the part of the shaft 3 provided with the external screw thread 3a is screwed into the internally threaded axial through hole of the transverse connector 8 to attach the assembly of the shaft 3, the connector 10 and the string 4 to the spearhead 2.

FIG. 6 shows the fisher 15 trying to catch a fish 17 lurking behind a rock undersea.

The fisher 15 selects a spearhead 2 suitable for catching a target fish 17 the fisher 15 desires to catch out of the plural different spearheads 2, and provides a baitfish 16. The baitfish 16 is put on the bait holder 6 of the spearhead 2. Then, the fisher 15 holding the fish spear 1 approaches a target fish 17. The target fish 17 senses the bloody smell and the like of the baitfish 16 and approaches the baitfish 16 cautiously and tries to attack the baitfish 16 aggressively. The fisher 15 can catch the target fish 17 by throwing the spearhead 2 and the shaft 3 toward the target fish 17 in proper timing.

Since the fisher 15 holding the fish spear 1 provided with the baitfish 16 on the bait holder 6 of the spearhead 2 approaches the target fish 17, the frequency of time suitable for catching the target fish 17 increases. Thus, the fisher 15 can enjoy thrilling spearing actions and can achieve a good catch of fish.

A spear gun 21 in another embodiment according to the present invention will be described with reference to FIG. 5. The spear gun 21 includes a spearhead 22, a gunbarrel 23, a shaft 24 and a string 27. The spearhead 22 is supported in the front end of the gunbarrel 23. The spearhead 22 is provided with a spearing tip 5 and a bait holder 6 similar to those shown in FIG. 1. A driving spring 25, namely, a driving means, is extended in the gunbarrel 23. A trigger mechanism 26 for releasing the compressed driving spring 25 is built in a lower part of the gunbarrel 23. The shaft 24 is extended through the gunbarrel 23 and is connected to the driving spring 25 in the gunbarrel 23. The string 27 has one end connected to a front part of the shaft 24 and the other end connected to the gunbarrel 23.

FIG. 5 shows the spear gun 21 prepared for spearing by pulling out a rear part of the shaft 24 from the rear end of the gunbarrel 23 to the right, as viewed in FIG. 5, to a limit to compress the driving spring 25. When the fisher operates the trigger mechanism 26 like triggering a handgun, the spearhead 22 and the shaft 24 are discharged to the left, as viewed in FIG. 5, from the gunbarrel 23. A rear part of the shaft 24 discharged from the gunbarrel 23 remains in the gunbarrel 23. The spearhead 22 and the shaft 24 can be prepared again for spearing by pulling the shaft 24 to the right, as viewed in FIG. 5, against the resilience of the driving spring 25.

To catch the target fish 17 with the spear gun 21 in the second embodiment, the fisher 15 puts a baitfish 16 on the bait holder 6 to lure the target fish 17, and operates the triggering mechanism 26 to discharge the spearhead 22 and the shaft 24 toward the target fish 17.

The driving means is not necessarily limited to the driving spring 25 and may be any suitable driving means, such as an electrical driving means.

1. A fish spear, to be used underwater for spearing a fish, said fish spear comprising:
a spearhead; and
a shaft connected to the spearhead;
wherein the spearhead has a spearing tip to be thrust into a fish to catch the fish, and a bait holder attached to the spearing tip to hold bait for luring a fish.

2. The fish spear according to claim 1, wherein the spearing tip has a sharp point and broadens toward its rear end, and the bait holder is attached to the spearing tip.

3. The fish spear according to claim 2, wherein the bait holder is extended along the outside surface of the spearing tip such that the bait holder can be thrust into a fish together with the spearing tip.

4. The fish spear according to claim 1, wherein the bait holder is provided with a barb for preventing bait put on the bait holder from falling off the bait holder.

5. The fish spear according to claim 1, wherein a transverse connector provided with an internal screw thread is attached to opposite inside parts of the spearing tip, the shaft has an externally threaded end, and the externally threaded end of the shaft is screwed into the internal screw thread of the transverse connector.

6. The fish spear according to claim 5, wherein the externally threaded end of the shaft can be screwed into each of spearing tips of different types.

7. The fish spear according to claim 1, wherein a string for controlling the released spearhead and shaft is connected to a front end of the shaft and is extended through the shaft.

8. The fish spear according to claim 1 further comprising a gunbarrel for holding and discharging the spearhead and the shaft, a driving means for discharging the spearhead and the shaft from the gunbarrel, and a trigger mechanism for actuating the driving means.

9. The fish spear according to claim 2, wherein the bait holder is provided with a barb for preventing bait put on the bait holder from falling off the bait holder.

10. The fish spear according to claim 3, wherein the bait holder is provided with a barb for preventing bait put on the bait holder from falling off the bait holder.

11. The fish spear according to claim 2, wherein a transverse connector provided with an internal screw thread is attached to opposite inside parts of the spearing tip, the shaft has an externally threaded end, and the externally threaded end of the shaft is screwed into the internal screw thread of the transverse connector.

12. The fish spear according to claim 3, wherein a transverse connector provided with an internal screw thread is attached to opposite inside parts of the spearing tip, the shaft has an externally threaded end, and the externally threaded end of the shaft is screwed into the internal screw thread of the transverse connector.

13. The fish spear according to claim 4, wherein a transverse connector provided with an internal screw thread is attached to opposite inside parts of the spearing tip, the shaft has an externally threaded end, and the externally threaded end of the shaft is screwed into the internal screw thread of the transverse connector.

14. The fish spear according to claim 9, wherein a transverse connector provided with an internal screw thread is attached to opposite inside parts of the spearing tip, the shaft has an externally threaded end, and the externally threaded end of the shaft is screwed into the internal screw thread of the transverse connector.

15. The fish spear according to claim 10, wherein a transverse connector provided with an internal screw thread is attached to opposite inside parts of the spearing tip, the shaft has an externally threaded end, and the externally threaded end of the shaft is screwed into the internal screw thread of the transverse connector.

16. The fish spear according to claim 11, wherein the externally threaded end of the shaft can be screwed into each of spearing tips of different types.

17. The fish spear according to claim 12, wherein the externally threaded end of the shaft can be screwed into each of spearing tips of different types.

18. The fish spear according to claim 13, wherein the externally threaded end of the shaft can be screwed into each of spearing tips of different types.

19. The fish spear according to claim 14, wherein the externally threaded end of the shaft can be screwed into each of spearing tips of different types.

20. The fish spear according to claim 15, wherein the externally threaded end of the shaft can be screwed into each of spearing tips of different types.
